(19) United States
(12) Patent Application Publication
(10) Pub. No.: US 2005/0091886 A1
(43) Pub. Date: May 5, 2005

(54) Origami and origami folding

(76) Inventor: Youngsock Kim, Coto De Caza, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/700,751

(22) Filed: Nov. 3, 2003

(51) Int. Cl. G09F 1/00

(52) U.S. Cl. 40/124.09; 428/9

(57) ABSTRACT

Disclosed are various constructions of origami papers and origamis using the origami paper. The origami papers include one or more various features, such as luminescence, fragrance and pressured folding lines. The fragrance and luminescence features can be introduced to origami papers by forming one or more layers of luminescent and/or fragrant materials. The pressured folding lines can be made by compressing the origami paper or its base material. The origami papers make paper folding easier and the resulting origamis more attractive. Also, disclosed are an origami kit including the featured origami papers and a themed collection of origamis.

### RELATED APPLICATIONS

This application is related to U.S. patent application Ser. No. ______, filed concurrently herewith and entitled “Origami Paper, Origami Kit and Origami Folding,” which is hereby incorporated by reference herein.

### BACKGROUND OF THE INVENTION

1. Field of the Invention

The present invention generally relates to arts and crafts. More particularly, the present invention relates to paper folding or origami.

2. Description of the Related Art

Origami is the art of paper folding used to make decorative shapes or sculptures. Also, the term, origami, refers to a decorative shape or sculpture made by such paper folding. Any plain paper for writing or printing on can be used for origami folding. But, origami folders often use special papers for origamis. Such special origami papers are generally squarely cut and made of paper or durable foil. Such special papers may be colored or pre-printed with ornamental designs.

### SUMMARY OF THE INVENTION

One aspect of the present invention provides an origami sheet. The origami sheet comprises: a flexible substrate configured to be foldable into an origami; and a luminescent material formed on the substrate, the material being configured to form a luminescent surface of the origami. The origami sheet further comprises a fragrant material formed on the substrate. The origami sheet further comprises a fragrant material formed over the luminescent material. The origami sheet further comprises a plurality of folding lines formed on the substrate. The folding lines comprise printed folding lines. The folding lines comprise a structure integrated into the sheet and configured to facilitate substantially precise folding of the sheet along the structures. The flexible substrate has a thickness selected from about 7 points to about 22 points. The origami sheet is substantially square. The flexible substrate is made of paper or plastic. The origami sheet is pre-printed. The origami sheet is pre-colored. The luminescent material is formed on a substantial area of one side of the substrate. The luminescent material is formed on at least 10% of the total area of one side of the substrate. The luminescent material comprises a glow-in-the-dark material.

Another aspect of the present invention provides a method of producing the above-described origami sheet. The method comprises: providing the flexible substrate; and applying the luminescent material on the substrate to form a luminescent layer. Another aspect of the present invention provides a method of producing an origami kit. The method comprises: providing a plurality of origami sheets as described above; and packaging the plurality of origami sheets. Another aspect of the present invention provides a method of making an origami. The method comprises: providing the above-described origami sheet; and folding the origami sheet a plurality of times to form the origami, wherein at least part of the luminescent surface forms an outer surface of the origami.

Another aspect of the present invention provides an alternative origami sheet. The origami sheet comprises: a substrate having first and second substantially planar surfaces; a first luminescent layer formed on the first surface of the substrate; and a second luminescent layer formed on the second surface of the substrate. The origami sheet further comprises a plurality of folding lines formed on the origami sheet. The flexible substrate has a thickness selected from about 1 point to about 500 points. The flexible substrate has a thickness selected from about 3 points and to about 50 points. The first luminescent layer has a first color, wherein the second luminescent layer has a second color, and wherein the first and second color substantially differ from each other. The first luminescent layer has a first color, wherein the second luminescent layer has a second color, and wherein the first and second color are substantially similar to each other. The origami sheet further comprises a fragrant layer formed over the first luminescent layer. The origami sheet further comprises another fragrant layer formed over the second luminescent layer. The fragrant layer comprises a substantially transparent fragrant material. The first luminescent layer is formed on a substantial area of the first surface. The first luminescent layer is formed on at least 20% of the total area of the first surface. The first luminescent layer is formed on substantially all of the first surface. The first luminescent layer comprises a photoluminescent material.

Another aspect of the present invention provides a method of producing the above-described origami sheet. The method comprises: providing the substrate having the first and second substantially planar surfaces; applying a first luminescent material on the first surface to form the first luminescent layer; and applying a second luminescent material on the second surface to form the second luminescent layer. Another aspect of the present invention provides a method of making an origami. The method comprises: providing the above-described origami sheet; and folding the origami sheet a plurality of times to form the origami, wherein at least part of the first luminescent layers forms a part of an outer surface of the origami, and wherein at least part of the second luminescent layers forms a part of an outer surface of the origami. Another aspect of the present invention provides a method of producing an origami kit. The method comprises: providing a plurality of origami sheets as described above; and packaging the plurality of origami sheets.

Still another aspect of the present invention provides an origami sheet. The origami sheet comprises: a flexible substrate configured for folding into an origami; and means for generating light formed on at least part of the flexible sheet. The flexible sheet comprises two substantially planar surfaces, and wherein the means for generating light is formed on both of the substantially planar surfaces. The flexible sheet comprises two substantially planar surfaces, and wherein the means for generating light is formed on a substantial area of one of the surfaces. The flexible substrate has a thickness selected from about 3 points and to about 50 points.

Still another aspect of the present invention provides an origami sheet, which comprises: a substrate configured to be foldable into an origami; and a fragrant material formed on the substrate, the material being configured to emit a fragrance. The origami sheet further comprises a layer formed over the fragrant material, the layer comprises a material substantially blocking emission of fragrance from the fragrant material. The layer substantially covers the fragrant material formed on the substrate. The layer is configured to be removed or released. The fragrant material is formed on at least part of the substrate. The substrate comprises two substantially planar sides, and wherein the fragrant material is formed on at least part of both sides of the substrate. The origami sheet further comprises a luminescent material formed on the substrate, the luminescent material being configured to form a luminescent surface of the origami. The luminescent material and the fragrant material are overlappingly formed on the substrate. The luminescent material and the fragrant material do not overlap with each other. The origami sheet further comprises a plurality of folding lines formed on the substrate, wherein the folding lines comprise at least one of a printed folding line and a structural folding line. The structural folding line is integrated into the substrate and configured so as to facilitate substantially precise folding of the sheet along the structure.

Another aspect of the present invention provides a method of producing the above-described origami sheet. The method comprises: providing the flexible substrate; and applying the fragrant material on the substrate to form a fragrant layer. Another aspect of the present invention provides a method of using the above-described origami sheet. The method comprises: providing the origami sheet; and folding the origami sheet a plurality of times to form the origami, wherein the origami emits fragrance from the fragrant material. Another aspect of the present invention provides a method of using an origami sheet. The method comprises: providing the above-described origami sheet, comprising the emission blocking layer over the fragrance material; folding the origami sheet a plurality of times to form the origami; and removing at least part of the emission blocking layer prior to, during or after the folding. Still another aspect of the present invention provides a method of producing an origami kit. The method comprises: providing a plurality of origami sheets as described above; and packaging the plurality of origami sheets.

A further aspect of the present invention provides an origami sheet, which comprises: a flexible sheet configured for folding into an origami; and means for emitting a scent, the means being formed on the flexible sheet. The scent emitting means is for emitting more than one kind of scent. The origami sheet further comprises means for blocking the scent to be emitted from the scent emitting means. The blocking means covers the emitting means.

A further aspect of the present invention provides an origami sheet, which comprises: a substantially flexible substrate for folding into an origami; a plurality of pressured or perforated folding lines formed on the substrate; wherein the pressured or perforated folding lines are configured so as to facilitate folding the sheet along the folding lines; and wherein the pressured or perforated folding lines are provided so as to form a predetermined shape of the origami after folding. The flexible substrate has a thickness selected from about 7 points to about 15 points. The origami sheet further comprises at least one luminescent material formed on the substrate. The origami sheet further comprises at least one fragrant material formed on the substrate. The origami sheet further comprises printed folding lines. The printed folding lines comprise at least one of solid lines and broken lines. At least part of the printed folding lines is formed along part of the pressured or perforated folding lines. The folding lines are substantially straight. The origami sheet further comprises at least one indicia of locations of the pressured or perforated folding lines. The at least one indicia is printed on the sheet. The origami sheet further comprises printed indicia of an order of folding along the perforated or pressured folding lines.

Another aspect of the present invention provides a method of producing the above-described origami sheet. The method comprises: providing the substantially flexible substrate; and exerting a force on the substrate along predetermined imaginary lines sufficient to cause the substrate to be perforated along the imaginary line or to memorize the forced lines, thereby forming perforated or pressured folding lines. Another aspect of the present invention provides a method of making an origami. The method comprises: providing the above-described origami sheet; and folding the origami sheet along the perforated or pressured folding lines a plurality of times to form the shape of the origami. Another aspect of the present invention provides a method of producing an origami kit. The method comprises: providing a plurality of origami sheets as described above; and packaging the plurality of origami sheets.

A still further aspect of the present invention provides an origami sheet, which comprises: a substantially flexible sheet for folding into an origami; means for facilitating folding of the sheet along a plurality of imaginary lines so as to form a predetermined shape; and wherein the folding facilitating means is integrated into the sheet.

Another aspect of the present invention provides an origami kit, which comprises: a plurality of origami sheets packaged together; wherein each origami sheet comprises a flexible substrate of a material configured to be foldable into an origami; wherein at least one of the origami sheets comprises one or more features selected from the group consisting of a luminescent layer formed over the substrate, a fragrant layer formed over the substrate, a perforated folding line integrated into the substrate, a pressured folding line integrated in the substrate and a luminescent coloring along a folding line. The at least one of the origami sheets further comprises printed folding lines. The origami kit further comprises instructions on how to fold one or more of the origami sheets into an origami. The instructions are in the form of a video presentation stored in a storage medium. The instructions are printed on at least one of the origami sheets. The instructions are printed on an instruction sheet separate from the origami sheet. The instructions are printed on a surface of a package for the origami kit. The instructions further includes how to add an effect on the origami folded using one or more of the origami sheets. The effect is one or more selected from the group consisting of drawing, coloring, applying a fragrant material, applying a luminescent material and attaching decorative pieces. The origami kit further comprises one or more objects configured to be attached onto a surface of one of the origami sheet or an origami folded from one or more of the origami sheets. The origami kit further comprises one or more stationery articles used in origami folding or to decorate one of the origami sheets or an origami folded from one or more of the origami sheets. The one or more stationery articles are selected from the group consisting of scissors, a perforator, a paper cutter, adhesive, adhesive tape, a crayon, paint, a paint brush, a pen and a marker.

Still another aspect of the present invention provides an origami sheet. The origami sheet comprises: a substantially flexible substrate for folding into an origami; a plurality of printed folding lines formed on the substrate; a plurality of colored portions following all or part of the printed folding lines; and wherein the plurality of colored portions are configured to outline a shape of the origami folded with the origami sheet. Each colored portion is colored in a luminescent color. Each colored portion is substantially straight. The plurality of colored portions is configured to conspicuously outline the shape of the origami body. The plurality of colored portions is a single color. The plurality of colored portions is two or more colors.

Still another aspect of the present invention provides a method of producing the above-described origami sheet, comprises: providing the flexible substrate; and printing the plurality of colored portions on the substrate. Still another aspect of the present invention provides a method of using an origami sheet. The method comprises: providing the above-described origami sheet; and folding the origami sheet a plurality of times to form the shape of the origami, wherein the plurality of colored portions substantially outline the shape of the origami.

A still further aspect of the present invention provides an origami sheet, which comprises: a substantially flexible substrate for folding into an origami; and one or more luminescent images printed on the substrate. The one or more luminescent images are surrounded by a non-luminescent area of the sheet. The one or more luminescent images are printed throughout the substrate. Two or more of the luminescent images are in different shapes. The one or more luminescent images are repetition of a single image shape.

One aspect of the present invention provides an origami. The origami comprises: an origami body comprises a plurality of foldings of at least one substantially flexible sheets; and at least one area on an outer surface of the origami body comprising a luminescent material. The flexible sheet has a thickness from about 5 points to about 19 points. The flexible sheet is made of a paper or plastic material. The plurality of foldings comprises at least three foldings of the at least one sheet. The plurality of foldings comprises at least one folding of an overlapped section of the at least one sheet, and wherein the overlapped section comprises a part of the sheet overlapping with another part of the sheet. The origami further comprises at least one fragrant area on an outer surface of the origami body, wherein the at least one area is configured to emit fragrance upon exposure to air.

Another aspect of the present invention provides a method of making the above-described origami. The method comprises: providing the at least one substantially flexible origami sheet comprises a luminescent material formed on the sheet; and folding the at least one origami sheet a plurality of times to form the origami body; and wherein at least part of the luminescent material forms the at least one luminescent area in the outer surface of the origami body. The plurality of foldings comprises at least five foldings of the at least one sheet. The plurality of foldings comprises at least one folding of an overlapped section of the at least one sheet, and wherein the overlapped section is where a part of the sheet is overlapped with another part of the sheet. The method further comprises drawing an element of the origami on the at least one origami sheet or on the outer surface of the origami body, wherein the drawing is performed prior to or during the folding, or after finishing the folding. The method further comprises attaching an element of the origami on the at least one origami sheet or on the outer surface of the origami body, wherein the attachment is performed prior to or during the folding, or after finishing the folding. The element for attachment has a luminescent material formed thereon. The element for attachment has a fragrant material formed thereon. The at least one origami sheet is folded along a plurality of pre-formed folding lines.

Another aspect of the present invention provides a method of making the origami. The method comprises: providing the at least one substantially flexible origami sheet; folding the at least one origami sheet a plurality of times to form the origami body; and forming the at least one luminescent area on the outer surface of the origami body. The plurality of foldings comprises at least seven foldings of the at least one sheet. The addition of the at least one luminescent area is performed prior to, in the process of or after the folding. The addition of the at least one luminescent area is one or more selected from the group consisting of: coloring, with a luminescent material, a surface of the at least one origami sheet or the origami body; drawing, with a luminescent material, an element on a surface of the at least one origami sheet or the origami body; and attaching an element comprises a luminescent material to a surface of the at least one origami sheet or the origami body. The at least one origami sheet comprises a luminescent material pre-formed thereon. The method further comprises forming a fragrant surface on the origami.

Another aspect of the present invention provides an origami, which comprises: an origami body comprises a plurality of foldings of at least one substantially flexible sheet, the origami body further comprises an outer surface; and means for generating light in the dark that is formed or attached to the outer surface. Another aspect of the present invention provides an origami, which comprises: an origami body comprises a plurality of foldings of at least one substantially flexible sheet; and at least one fragrant area on an outer surface of the origami body, wherein the at least one area is configured to emit a fragrance upon exposure to air. The at least one fragrant area is covered with a blocking material, which can be removed to expose the fragrant section to the air, thereby releasing a fragrant scent. The plurality of foldings comprises at least four foldings of the at least one sheet. The flexible sheet has a thickness from about 6 points to about 17 points. The outer surface comprises a surface of the at least one sheet constituting a part of the origami body that can be observed from the outside of the origami without unfolding the folded origami body.

A further aspect of the present invention provides a method of making the above-described origami. The method comprises: providing the at least one substantially flexible origami sheet comprises a fragrant material formed on the sheet; and folding the at least one origami sheet a plurality of times to form the origami body; and wherein at least part of the fragrant material constitutes the at least one fragrant area in the outer surface of the origami body. The plurality of foldings comprises at least six foldings of the at least one sheet. The at least one fragrant area is covered with a blocking material, and wherein the method further comprises removing the blocking material to expose the fragrant material. The method further comprises drawing on the at least one origami sheet or on the outer surface of the origami body, wherein the drawing is performed prior to or during the folding, or after finishing the folding. The method further comprises attaching an element on the at least one origami sheet or on the outer surface of the origami body, wherein the attachment is performed prior to or during the folding, or after finishing the folding.

A further aspect of the present invention provides a method of making the above-described origami. The method comprises: providing the at least one substantially flexible origami sheet; folding the at least one origami sheet a plurality of times to form the origami body; and forming the at least one fragrant area on the outer surface of the origami body. The addition of the fragrant area is performed prior to, in the process of or after the folding. The addition of the fragrant area is one or more selected from the group consisting of: applying a fragrant material on a surface of the at least one sheet or the origami body; and attaching an element comprises a fragrant material on a surface of the at least one sheet or origami body. The method at least one origami sheet comprises a fragrant material pre-formed thereon. The method further comprises forming at least one luminescent area on the outer surface of the origami body. The at least one origami sheet comprises a luminescent material pre-formed thereon. The plurality of foldings comprises at least eight foldings of the at least one sheet.

A still further aspect of the present invention provides an origami, which comprises: an origami body comprises a plurality of foldings of at least one substantially flexible sheet, the origami body further comprises an outer surface; and means for emitting a scent upon exposure to air, the means being formed on or attached to the outer surface of the origami body. A still further aspect of the present invention provides an origami, which comprises: an origami body forming a shape, the shaped origami body comprises a plurality of foldings of at least one substantially flexible sheet; a plurality of colored portions formed on the origami body; and wherein the plurality of colored portions substantially outlines the shaped of the origami body. Each colored portion is colored in a luminescent color. The plurality of colored portions is colored in a single color. The plurality of colored portions is colored in two or more colors. Each colored portion comprises a substantially straight line. The plurality of colored portions is formed along all or part of the foldings. The plurality of colored portions conspicuously outlines the shape of the origami body.

A still further aspect of the present invention provides a method of making the above-described origami. The method comprises: providing the at least one substantially flexible origami sheet; folding the at least one origami sheet a plurality of times to form the shaped origami body; and applying the plurality of colored portions on the at least one flexible origami sheet or the shaped origami body so as to substantially outline the shape of the origami body. The plurality of colored portions is added in the process of or after finishing the folding. A still further aspect of the present invention provides a method of making the above-described origami. The method comprises: providing the at least one substantially flexible origami sheet; and folding the at least one origami sheet a plurality of times to form the shaped origami body; wherein the plurality of colored portions is pre-formed on the at least one origami sheet.

### BRIEF DESCRIPTION OF THE DRAWINGS

FIGS. 1A-1C are perspective views of various origamis in accordance with an embodiment of the present invention.

FIGS. 2, 4 and 5 illustrate intermediate forms of origami paper during the process of making an origami in accordance with an embodiment of the present invention.

FIG. 3 illustrates an attachable element of an origami in accordance with an embodiment of the present invention.

FIGS. 6-10 and 12-17 are cross-sectional views of various origami papers in accordance with embodiments of the present invention.

FIG. 11 illustrates scratching on a surface of an origami paper in accordance with an embodiment of the present invention.

FIGS. 18A and 18B illustrate an origami sheet and an origami folded from the sheet in accordance with an embodiment of the present invention.

### DETAILED DESCRIPTION OF EMBODIMENTS

Various aspects of the present invention will be discussed in more detail. It is to be understood at the outset of the description that persons of skill in the appropriate arts may modify the invention here described while still achieving the favorable results of this invention. Accordingly, the following description is to be understood as being a broad, teaching disclosure directed to persons of skill in the appropriate arts, and not as limiting upon the present invention.

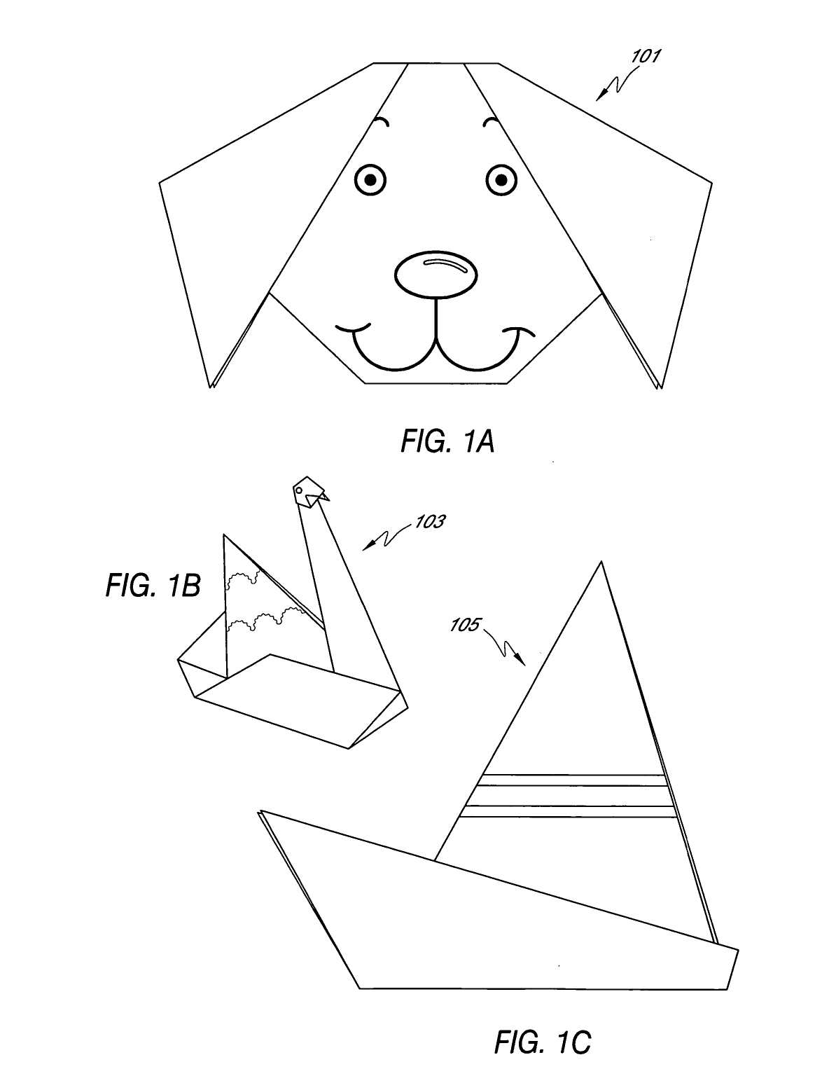

FIG. 1 illustrates exemplary origamis in accordance with various embodiments of the present invention. The illustrated origamis are a dog-face origami 101, a swan origami 103 and a sailboat origami 105. These origamis 101, 103 and 105 includes one or more features of the present invention, such as a luminescent surface, a fragrant surface, pressured folding lines, perforated folding lines, colored portions for outlining the origami shape, which will be further discussed in detail. The features of the present invention are not limited to the particular shape, configuration or construction of the origamis shown in FIG. 1.

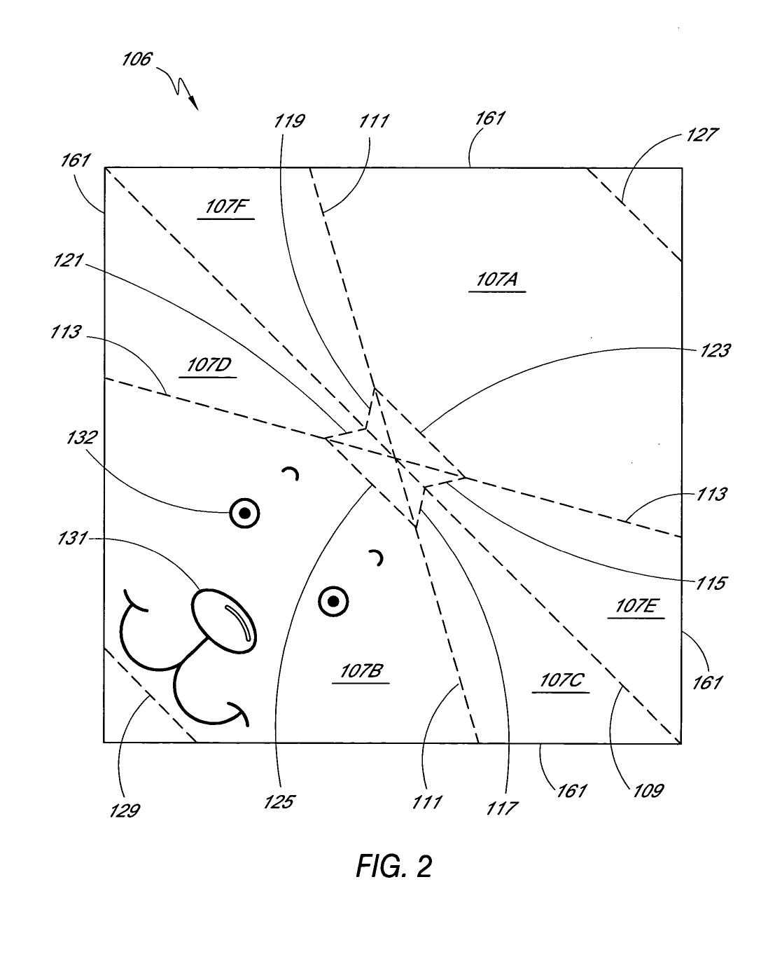

FIG. 2 illustrates a front side of an unfolded origami paper 106 for the dog-face origami 101 of FIG. 1 in accordance with an embodiment of the present invention. Here and throughout this disclosure, the word “paper” in the term “origami paper” is not limited to a paper material, but refers to a sheet of any material that is substantially flexible or pliable to fold. Further, the origami paper according to various embodiments of the present invention may include one or more layers of other materials formed on the sheet. The materials for the origami sheet and the construction of various layers will be discussed later.

The front side of the origami paper 106 is divided into sections 107A, 107B, 107C, 107D, 107E, and 107F, and other sections that are not designated by reference numbers, including the areas defined by three or more of lines 111, 113, 115, 117, 119, 121, 123, 125 in the center. In one embodiment, each of these sections is colored and/or toned differently from their neighboring sections or areas. In another embodiment, two or more neighboring sections may have the same color or tone. In still another embodiment, one or more of the sections may have two or more colors and/or tones in them. The color of these sections is formed by printing on the sheet.

Techniques for printing the colored sections on the sheet include, for example, screen-printing, eletctrophotography, flexography, offset printing, indigo printing, inkjet printing and thermal transfer. Any other printing techniques available to those of ordinary skill in the art may also be employed for the printing of the colors of the sections. Depending upon the techniques employed in the printing, those of ordinary skill in the art would understand appropriate inks for generating colors. Inks with a luminescence effect may be used for printing colored sections. In another embodiment, the front side of the origami paper 106 may be printed in a single color and in a single tone, rather than forming multiple sections of different colors and/or tones. Further, in another embodiment, the origami paper 106 may not be printed at all.

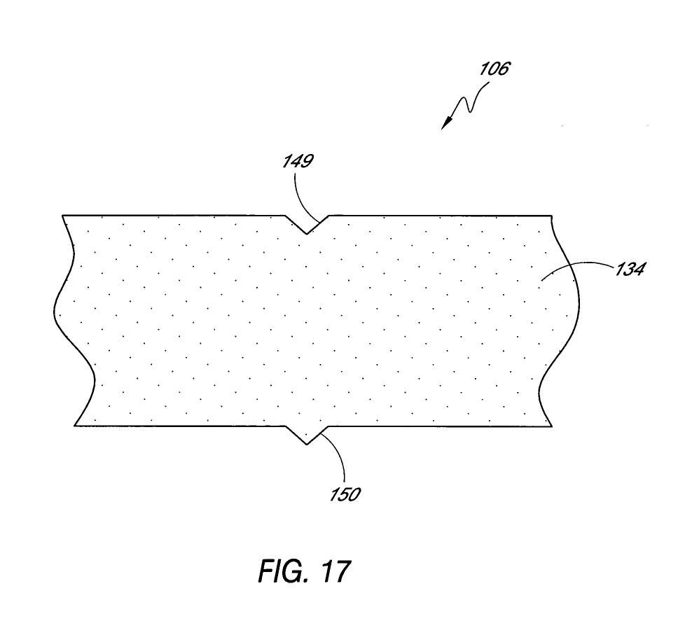

The front side of the origami paper 106 includes a number of folding lines 109, 111, 113, 115, 117, 119, 121, 123, 125, 127 and 129, which are substantially straight or linear, although they are not limited thereto. In this embodiment, the folding lines 109, 111, 113, 115, 117, 119, 121, 123, 125, 127 and 129 are drawn in dotted lines. In another embodiment, however, the folding lines 109, 111, 113, 115, 117, 119, 121, 123, 125, 127 and 129 may be drawn in non-dotted lines. The folding lines may be printed in any color. Alternatively, the folding lines may be formed by non-printed lines, whether dotted or not. In an embodiment, the folding lines may be printed with a luminescent material. In another embodiment, the folding lines may be constructed as perforations on the sheet. In still another embodiment, the folding lines may be pressured folding lines on the sheet, which will be further discussed below with reference to FIG. 17. Not all of the folding lines of an origami paper 106 may be formed or constructed in the same way. The folding lines of the origami paper 106 may be formed in a combination of various forms as described above. In still another embodiment, the folding lines may not be drawn at all.

Still in the embodiment of the origami paper 106, elements 131 and 132 of the dog-face, including, for example, eyes, eyebrows, nose and mouth lines are pre-drawn on the front side. The term “elements” 131 and 132 refers to any drawings on or attachments to the origami paper other than the folding lines. The attachments may be two- or three-dimensional. In an origami having a plurality of elements, the elements 131 and 132 may be a combination of drawings and attachments. Preferably, the elements 131 and 132 are formed in the course of forming the colored sections 107A, 107B, 107C, 107D, 107E, 107F and other colored sections. However, the elements 131 and 132 may be formed in a separate process of printing or coating thereof. The elements 131 may or may not be colored differently from their surrounding.

In another embodiment, although not illustrated, the elements 131 and 132 may be pre-drawn on the origami paper 106 in an unfinished form. For example, the unfinished pre-drawn elements may be in the form of boundary lines for coloring or further drawing. The boundary lines may be in dotted lines and/or solid lines. Optionally, the pre-drawn lines are lightly printed. The unfinished elements would provide origami folders with the opportunity of coloring or elaborating the elements of the origami, as they like, before, during or after the origami folding. Alternatively, origami folders may attach elements over the boundary lines of the elements 131 and 132 before, during or after the origami folding.

In another embodiment, the elements 131 and 132 of the origami may not be pre-drawn at all. Then, an origami folder may draw or attach such elements before, during or after the origami folding. In this embodiment of undrawn elements, the origami paper is preferably provided with instructions or information about drawing or attaching elements, including where and what kinds of elements can be drawn. Alternatively and additionally, the origami paper is preferably provided with an exemplary picture showing the folded origami with elements.

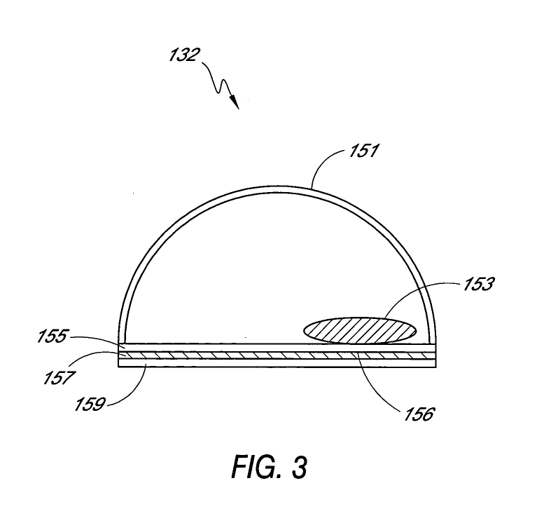

In the embodiments including one or more elements as attachments, the origami paper may be provided with pre-made attachable elements or materials or kits for making such attachable elements. In an embodiment, the attachments or attachable elements may be related to the shape or theme of the origami to fold with the origami paper. As described below with reference to FIG. 3, for example, the attachable element 132 is an eye of the dog origami. Alternatively, the attachments or attachable elements may not be related to the shape or theme of the origami to fold with the origami paper. Any arbitrary shaped elements may be attached on the origami paper prior to, during or after folding the origami paper. For example, star-shaped or flower-shaped elements may be attached on the origami paper for a dog or a finished dog-shaped origami. The arbitrary shaped elements may or may not be pre-made. Optionally, the attachments or attachable elements may have at least one of the features of a luminescent layer and a fragrant layer, which are further discussed below.

Optionally, the attachable elements are provided with instructions on where and how to attach. Also, materials or kits for making attachable elements may be provided with instructions on how to make them, as well as the instructions on where and how they should be attached. In the case where the materials to make elements are provided, instructions and information on how to make the elements are additionally provided. It is preferable that the attachable elements or the materials to have a surface of attachment for attaching onto a surface of the origami or the origami paper. Preferably, the attachment surface of the attachable elements or the materials to make them is substantially flat. In one embodiment, a layer of tacky material is formed on the attachment surface, like a sticker. Optionally, a liner layer of a removable material is formed on the tacky material layer.

FIG. 3 illustrates a pre-made attachable element 132, which is, for example, the eye of the dog-face. The pre-made attachable element 132 includes a transparent dome 151 attached on a backing 155. A pupil 153 is enclosed in the space defined by the dome 151 and backing 155. The backing 155 has a bottom surface 156, which is substantially flat. A layer 157 of a tacky material is formed on the bottom surface 156. Those of ordinary skill in the art would well understand what type of tacky materials are suitable for use in the tacky layer 157. A liner layer 159 covers the tacky layer 157. This pre-made attachable element 132 can be attached on the origami paper 106 by peeling the liner layer 159 and contacting the tacky layer 157 on the surface of the origami paper 106. The attachable element 132 may be attached on the origami paper before, during or after the origami folding.

Although not illustrated, the rear side of the origami paper 106 may have one or more features of the front side, as described above. Alternatively, the rear side of the origami paper 106 may be a blank surface, which do not have any of the above-described features of the front side.

The origami paper 106 may be in any two-dimensional shape. In one embodiment, however, the origami paper 106 is a square, in which four edges 161 are in about the same length, or a rectangle, in which two of the edges 161 are longer or shorter than the other two. Alternatively, the origami paper 106 may be in other polygonal shapes, such as pentagonal, hexagonal, heptagonal, octagonal, etc. The other polygonal shapes are preferably in a regular polygonal, edges of which have substantially the same length.

The origami paper 106 may be formed in any sizes. However, certain specific embodiments will now be described. In one embodiment, the longest edge of origami paper 106 is advantageously from about 2 inches to about 30 inches. In other embodiments, the longest edge may be from about 4 inches to about 24 inches, or from about 6 inches to about 12 inches. The shortest edge of the origami paper 106 may be from about 2 inches to about 30 inches. In other embodiments, the shortest edge may be from about 4 inches to about 24 inches, or from about 6 inches to about 12 inches. Optionally, the origami paper 106 is in a square shape with 3×3, 4×4, 5×5, 6×6, 7×7, 8×8, 9×9, 10×10, 11×11, 12×12, 13×13, etc. all in inches. Preferably, the square origami paper 106 is 6×6, 8×8, 10×10 in inches.

In an embodiment, the origami paper 106 may be part of a larger sheet with one or more margins abutting the edges 161 of the origami paper 106. FIG. 2 itself shows four margins around the four edges 161 of the origami paper 106. An edge 161 abutting a margin is preferably perforated to facilitate separating the origami paper 106 from the abutting the margin. With the one or more margins, a plurality of origami papers may be bound in a book. In another embodiment, the origami paper 106 itself forms a single sheet, without a margin around the edges 161. In this case, a plurality of origami papers may be kept together in a wrapping material.

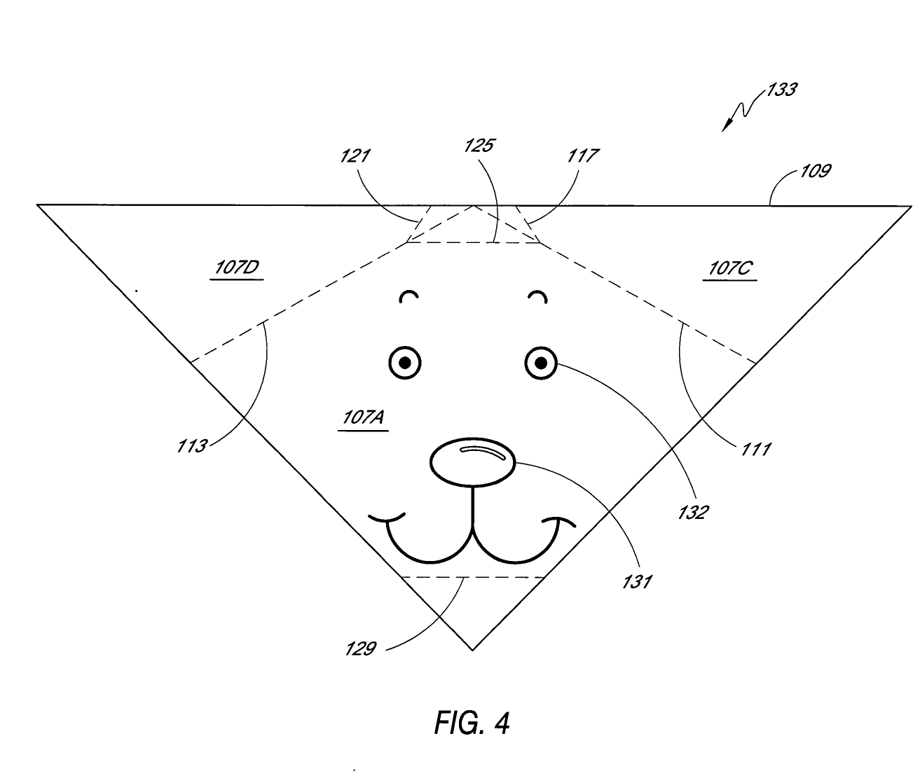

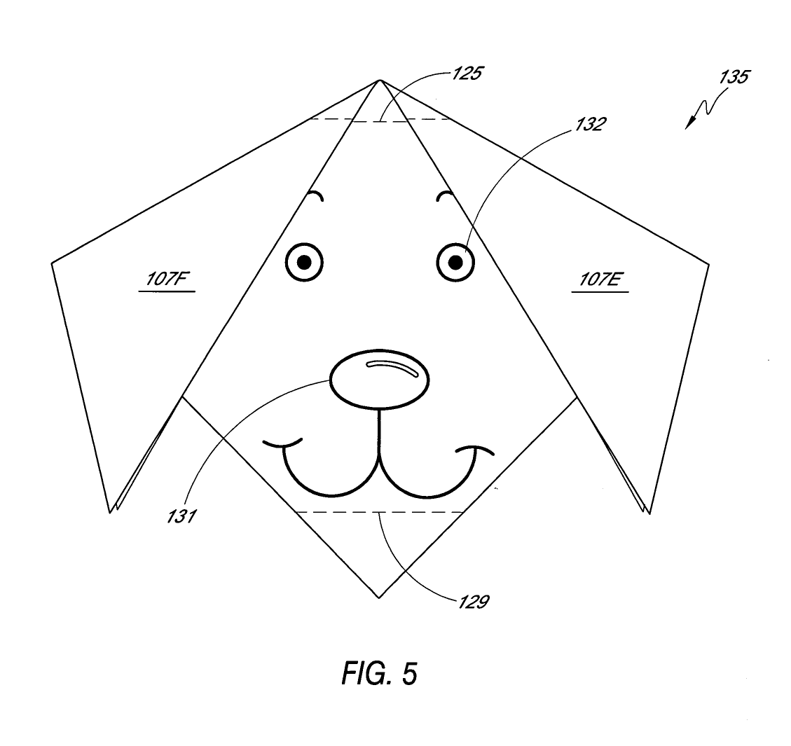

FIGS. 4 and 5 illustrate intermediate shapes 133 and 135 formed as the origami paper 106 is folded for the dog-face origami 101. The intermediate shape 133 of FIG. 4 can be formed by folding the origami paper 106 of FIG. 2 backward along the folding line 109 and overlapping the two areas divided by the folding line 109. The intermediate shape of 135 of FIG. 5 can be formed from the shape 133 by folding the sections 107C and 107D toward the front direction of the sheet along the folding lines 111 and 113, respectively. Then, folding the areas above the folding line 125 and below the folding line 129 backward along the folding lines 125 and 129, respectively, will finish the dog-face origami 101 of FIG. 1.

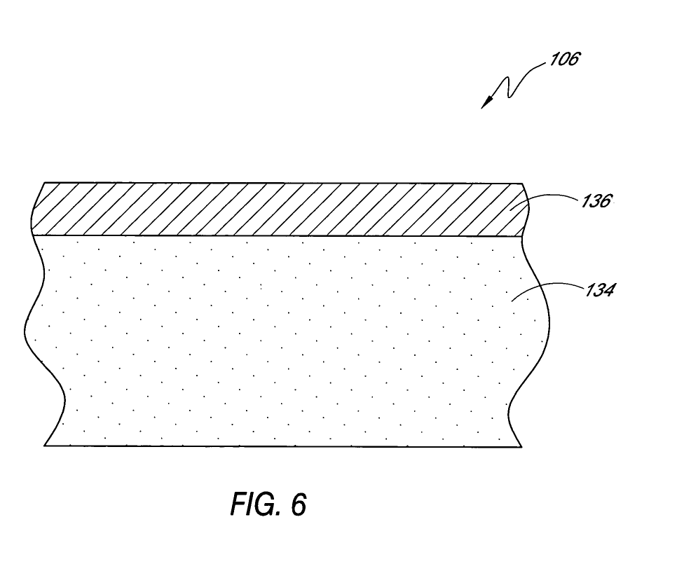

FIG. 6 illustrates a cross-sectional view of the origami paper 106 in accordance with an embodiment of the present invention. The origami paper 106 includes a substrate 134 and a luminescent layer 136 formed on the substrate 134. The substrate 134 is substantially flexible and foldable so as to fold into an origami. The substrate 134 can be made of any material that can provide such substantial flexibility and foldability. Preferably, the substrate 134 is made of a paper material including cellulose pulp, metallic foil, plastic material, fabric or any other materials, with which a foldable film or sheet may be produced. The substrate 134 may be formed of a single layer of a single material. Preferably, the substrate 134 is made of a paper material. Alternatively, the substrate 134, although not drawn, may be formed of multiple layers of a single material. Still alternatively, the substrate 134 may be formed of multiple layers made of two or more different materials. For example, the substrate 134 may be formed of a layer of a paper material and another layer of metallic foil.

The substrate 134 may have any thickness as long as the resulting origami paper 106 has substantial flexibility and foldability. The thickness of the substrate 134 is substantially similar throughout the locations thereof. In embodiments, the substrate 134 has a thickness from about 1 point to about 500 points. Here, one point is 1/1000th of an inch or 0.001 inch. Preferably, the thickness of the substrate 134 is from about 3 points and to about 50 points, more preferably from about 6 points to about 20 points. The description of the substrate 134 with reference to FIG. 6 applies to the substrates 136 in any other drawings unless specifically noted otherwise.

The luminescent layer 136 is provided to create the effect of luminescence. The luminescence effect refers to emission of visible light from a material by internal processes of the material. Generally, the internal processes includes receiving by the materials a form of energy, which excites certain electrons of the molecules in the material, and emitting visible light when the excited electrons return to their ground states. The luminescence effect includes, for example, photoluminescence or glow-in-the-dark, in which the energy is received in the form of light or photons. Although not described in detail, the luminescence may include electroluminescence, in which the energy is received in the form of electricity.

The luminescent layer 136 contains one or more materials that can create luminescence effect. The materials for use in the luminescent layer 136 may be either fluorescent or phosphorescent luminescent materials, which would be appreciated by those of ordinary skill in the art. Preferably, the materials are phosphorescent materials. Optionally, the materials are those that can excite electrons and emit visible light upon receipt of visible light, invisible propagation of energy or electricity. Those of ordinary skill in the relevant art would well appreciate the materials for use in the luminescent layer 136. The luminescent layer 136 contains one or more luminescent materials in an amount that can generate an intensity of light that can be detected by naked eyes in a dark environment. Although not illustrated or described in great detail, the luminescent layer 136 may be electricity driven and may require an electrical circuit. Those of ordinary skill in the art of luminescent materials and related art would be able to select appropriate luminescent materials for the luminescent layer 136 and/or any necessary parts for the luminescence effect.

The color of visible light that can be generated differs from material to material. The luminescent layer 136 may include any material regardless of the color of light it emits. The luminescent layer 136 may contain two or more different materials generating different colored lights. Then, the light emitted from the luminescent layer 136 would be another color created by the mixture of the different colored lights from the different materials. Although the luminescent layer 136 is drawn as a single layer, it may have two or more sublayers, which contains the same or a different material. In the case of different material(s) in each sublayer, the luminescent layer 136 overall may generate a color of light, which is different from the colors from the individual sublayer. If necessary, the luminescent layer 136 may contain an adhesive to bind the luminescent material(s) together and/or to bind the layer 136 onto the substrate 134. Further, the luminescent layer 136 may contain a diluent and other additives, if preferred.

As illustrated, the luminescent layer 136 may be constructed as a continuous layer over throughout the substrate 134. The continuous luminescent layer 136 may have two or more regions having different luminescent materials therein for different colors. Alternatively, plural continuous areas of the luminescent layer 136 may be discontinuously formed on the substrate 134. In the construction of discontinuous areas of the luminescent layer 136, a continuous area may have two or more regions having different luminescent materials therein for different colors. Optionally, the discontinuous areas are formed along one or more folding lines. Further, the discontinuous luminescent areas are formed along certain selected folding lines only so as to delineate or outline the shape of the origami. The luminescent layer 136 is formed in a thickness sufficient to create the luminescent effect. Those of ordinary skill in the relevant art would appreciate the sufficient thickness of the luminescent layer 136. The above description and discussion of the luminescent layer 136 with reference to FIG. 6 apply to any luminescent layer(s) of other embodiments and constructions in other drawings unless specifically noted otherwise.

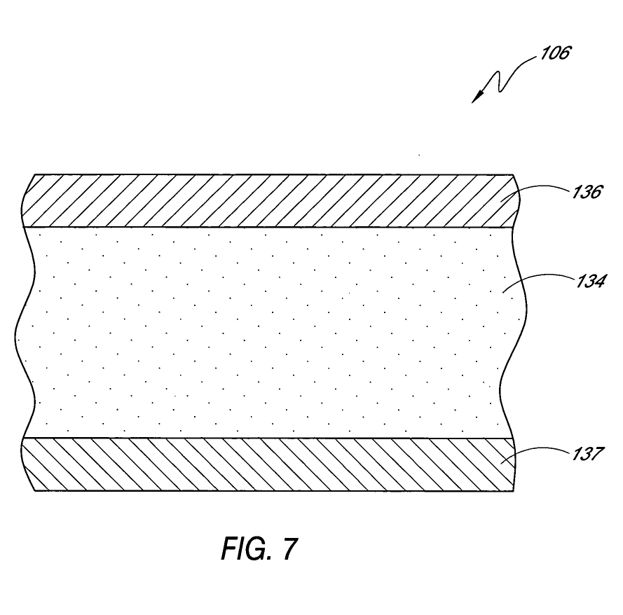

FIG. 7 illustrates a sandwich construction of the origami paper 106 in accordance with an embodiment of the present invention. In this construction, a substrate 134 is sandwiched between two luminescent layers 136 and 137. The luminescent layers 136 and 137 may have different thicknesses. Also, the two luminescent layers 136 and 137 may contain different composition of materials. The two luminescent layers 136 and 137 may emit the substantially same colored light. Alternatively, the two luminescent layers 136 and 137 may emit substantially different colored lights. The two luminescent layers 136 and 137 may contain light-emitting materials different from each other. Further, the construction of sublayers, if any, may be different between the two luminescent layers 136 and 137.

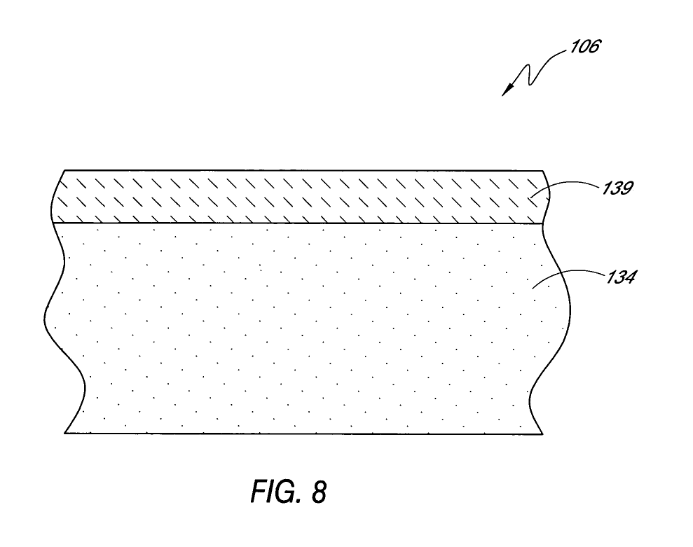

FIG. 8 illustrates a cross-sectional view of the origami paper 106 in another embodiment of the present invention. The origami paper 106 includes a substrate 134 and a fragrant layer 139 formed on the substrate 134. The fragrant layer 139 is to emit fragrance or smell from the origami paper 106 or the origami folded therefrom. The fragrant layer 139 may contain any materials to emit any fragrance or smell. Fragrance that people generally associate with as a refresher such as flowers, fruits, foods, woods, vegetables, beverages, liquors and so forth would be preferred although not limited thereto. One of ordinary skill in the relevant art including the field of fragrant materials would appreciate fragrant materials for use in the fragrant layer 139.

In an embodiment where the origami paper 106 is designed to fold a particular origami, for example, by printed folding lines for that origami, the fragrant layer 139 may contain one or more materials to give off fragrance or smell that is associated with the particular origami, although not limited thereto. For example, an origami paper designed for a flower may contain one or more fragrant materials for fragrance of a flower in its fragrant layer 139. More particularly, if the origami paper is for folding a rose, the fragrant layer 139 may contain a fragrant material for rose flowers. Also, as an example, an origami paper configured for folding a shape of a particular fruit may contain fragrant materials for that fruit. If necessary, the fragrant layer 139 may contain an adhesive to bind the fragrant material(s) together and/or to bind the layer 139 onto the substrate 134. Further, the fragrant layer 139 may contain a diluent and other additives, if preferred.

As illustrated, the fragrant layer 139 may be constructed as a continuous layer over throughout the substrate 134. The continuous fragrant layer 139 may have two or more regions having different fragrant materials therein for different smells. Alternatively, plural areas of the fragrant layer 14 may be discontinuously formed on the substrate 134. In the discontinuous construction, a continuous area of the fragrant layer 139 may have two or more regions having different fragrant materials therein for different smells. The fragrant layer 139 is formed in a thickness sufficient to create the effect of emitting fragrance or smell. The above description and discussion of the fragrant layer 139 with reference to FIG. 8 apply to any fragrant layer(s) of other embodiments and constructions in other drawings unless specifically noted otherwise.

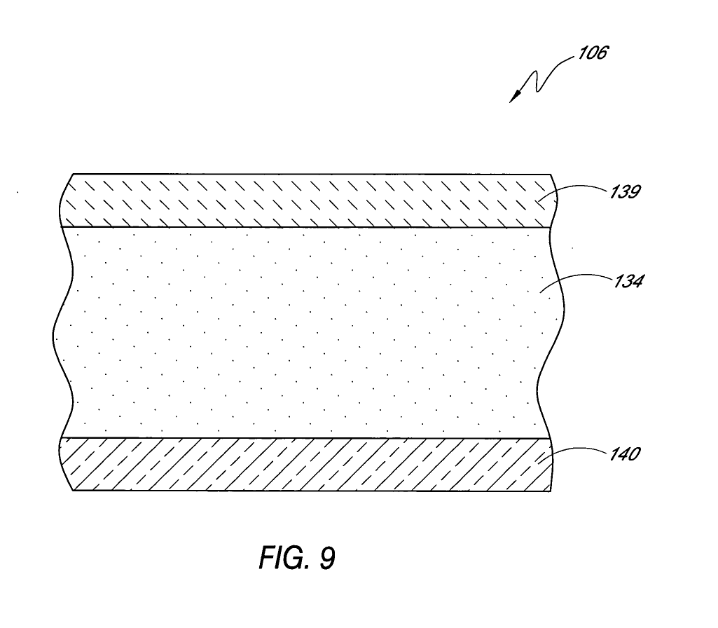

FIG. 9 illustrates a sandwich construction of the origami paper 106 in accordance with an embodiment of the present invention. In this construction, a substrate 134 is placed between two fragrant layers 139 and 140. The fragrant layers 139 and 140 may have different thicknesses. Also, the two fragrant layers 139 and 140 may contain different composition of materials. The two fragrant layers 139 and 140 may give off the substantially same fragrance. Alternatively, the two fragrant layers 139 and 140 may emit substantially different fragrances. The two fragrant layers 139 and 140 may contain fragrant materials different from each other.

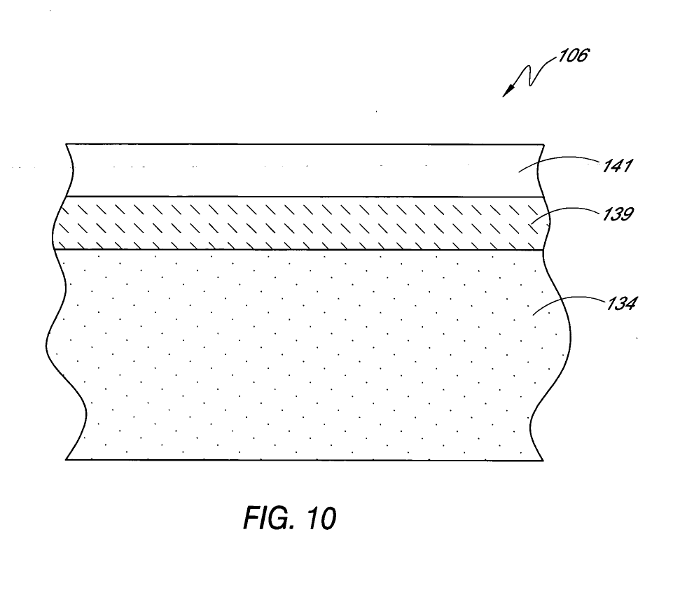

FIG. 10 illustrates another embodiment of the origami paper 106 including a fragrant layer 139. The fragrant layer 139 is formed on a substrate 134 and covered by a blocking layer 141. The blocking layer 141 is to prevent the fragrant layer 139 from being exposed to the air and generally to avoid or minimize loss of the fragrance before the origami folding. The blocking layer 141 may be removable partly or completely to expose the fragrant layer 139 to the air, thereby emitting the fragrance therefrom.

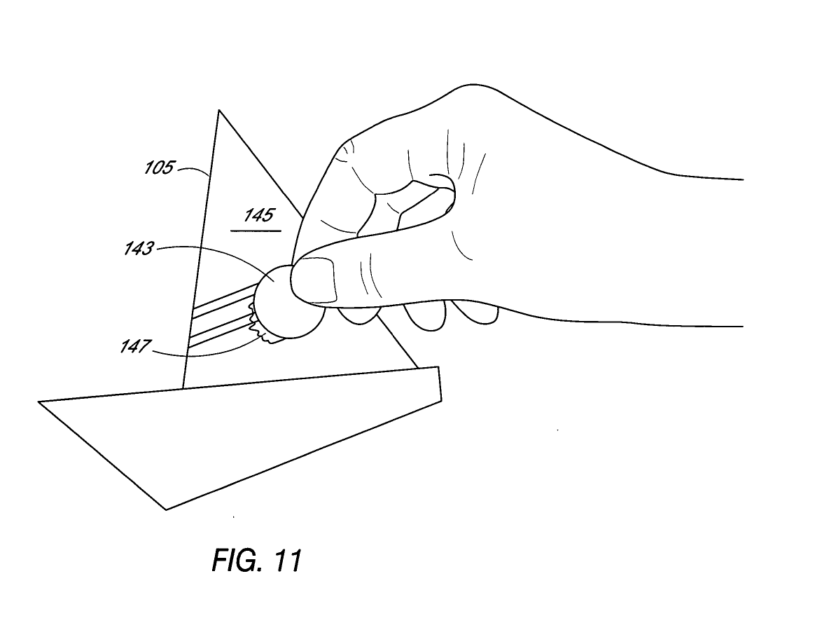

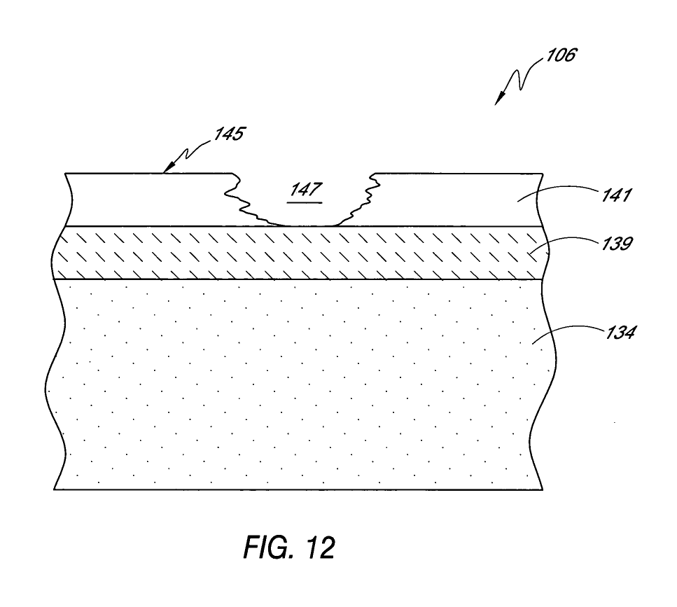

The blocking layer 141 contains one or more materials that can effectively block emission of fragrance material from the fragrant layer 139. The blocking layer 139 may be formed with, for example, paraffin. The thickness of the blocking layer 141 may vary depending upon the material used. Regardless, the blocking layer 141 has a thickness sufficient to block the giving-off of the fragrant materials from the underlying fragrant layer 139. The blocking layer 141 may be removed in various ways. Sometimes, the materials used for the blocking layer 141 may determine the way it is removed. In one embodiment, the blocking layer 141 may be scratched off. As illustrated in FIG. 11, one can scratch the surface 145 of the origami 105 with an article, for example with a coin 143. The scratching may remove some area of the blocking layer 141 and create an opening 147 to expose at least part of the fragrant layer 139 as also illustrated in FIGS. 11 and 12. Although FIG. 11 shows the origami 105 as folded, the scratching may be done before or in the middle of the folding the origami 105.

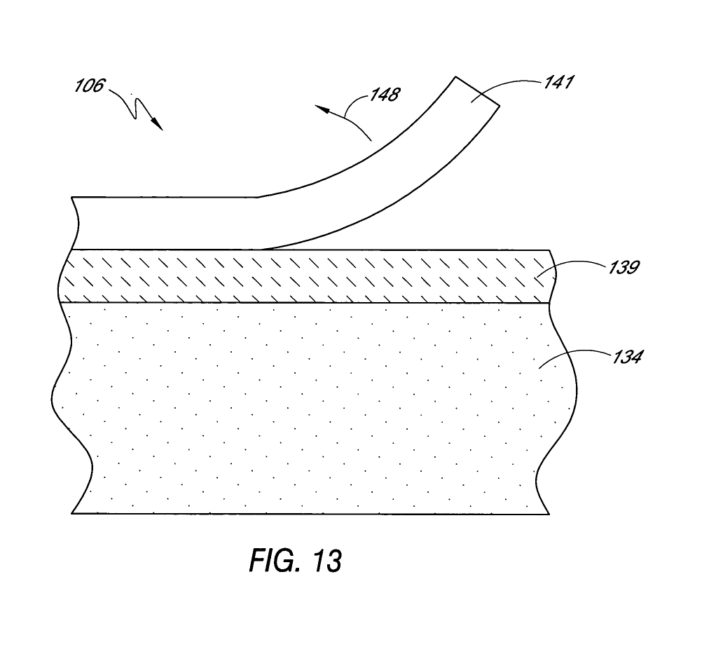

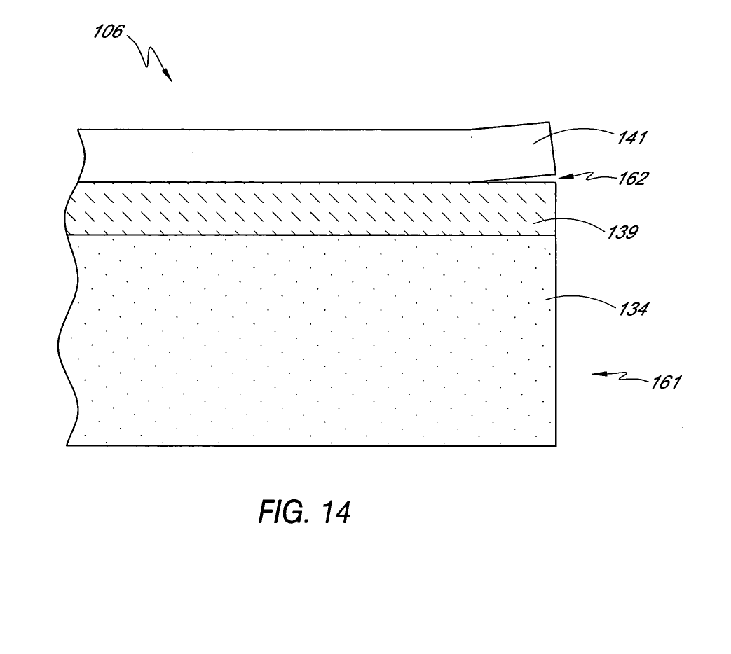

In another embodiment, the blocking layer 141 may be peeled off. As illustrated in FIG. 13, the blocking layer 141 may be pulled in the direction of the arrow 148 and peeled off from the top surface of the fragrant layer 139. In this embodiment, a layer of lubricating or peeling agent may be formed between the blocking layer 141 and the fragrant layer 139 to facilitate the peeling of the blocking layer 141. As illustrated in FIG. 14, in an area along the edge 161 of the origami paper 106, the blocking layer 141 is not completely bound to the underlying fragrant layer 139, leaving a gap 162 therebetween. The gap 162 makes easy separation of the blocking layer 141 from the fragrant layer 139, thereby facilitating the removal of the blocking layer 141. The above description and discussion of the blocking layer 141 apply to any other embodiments and constructions in other drawings unless specifically noted otherwise.

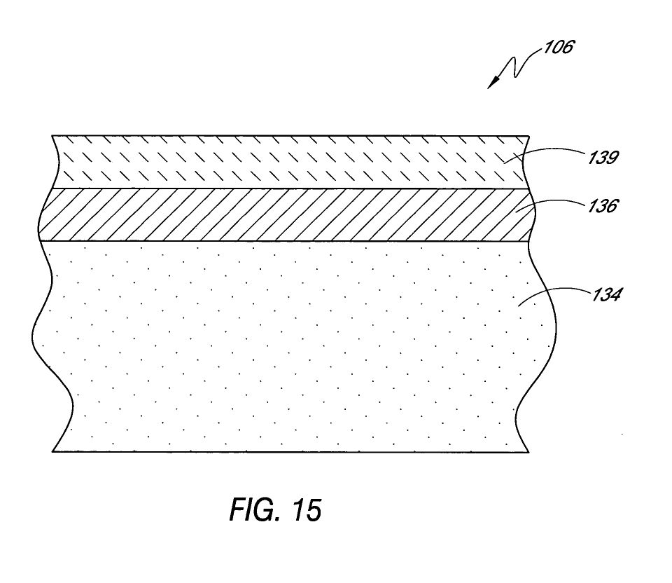

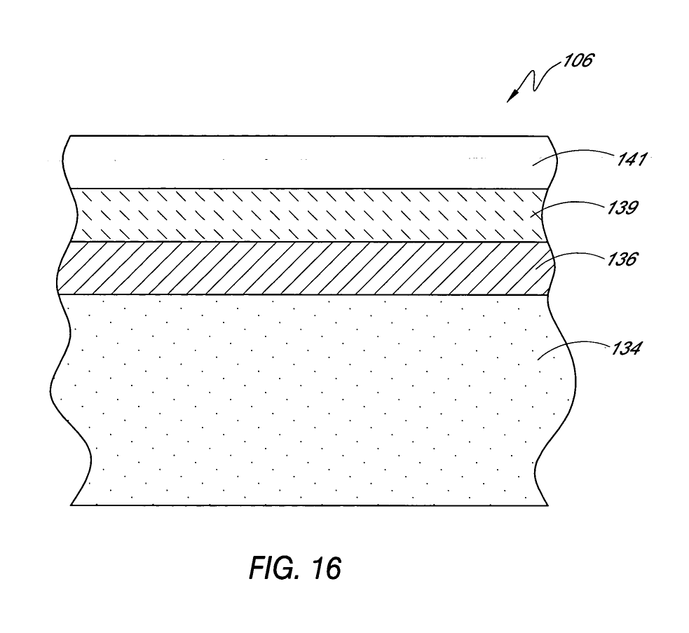

FIGS. 15 and 16 illustrate additional embodiments of the origami paper 106. The embodiment of FIG. 15 has a substrate 134 supporting a luminescent layer 136 and a fragrant layer 139. As illustrated, the fragrant layer 139 is preferably placed over the luminescent layer 136, although not limited to this order. The embodiment of FIG. 16 has a blocking layer 141 over the fragrant layer 13 of the construction of FIG. 15. Although not illustrated, any combinations of the luminescent layer 136, fragrant layer 139 and/or blocking layer 141 may also be formed on the other side (bottom) of the substrate 134. The combinations on the bottom side of the substrate 134 may or may not be the same as the constructions shown in FIGS. 15 and 16.

In any constructions of the origami paper 106 having one or more layers formed on or over the substrate 134, the materials used in the various layers would not interfere viewing any a pattern made, printed or drawn on or in the substrate 134 or any underlying layers thereof. Further, in any constructions of the origami paper 106 having one or more layers formed on or over the substrate 134, each layer may or may not cover substantially all of the surface of the substrate 134 or its underlying layer. The printing or coloring described with reference to FIG. 2 is generally made on the substrate 134. However, the printing or coloring may be made on another layer formed on or over the substrate 134. The inks or other materials used for the printing or coloring may move into the surface of the substrate 134 or the layer on which the printing or coloring is made. Alternatively, the inks or other materials may form a print or color layer (not shown) over the surface of the substrate 134 or its underlying layer.

FIG. 17 illustrates a cross-section of another embodiment of an origami paper 106 with a notch 149 on the top of a substrate 134 and a corresponding projection 150 on the bottom thereof. The notch 149 and projection 150 of FIG. 17 extend toward the front or back of the drawing sheet and represent a cross-section of a pressured folding line. The pressured folding line refers to a line of compression on the substrate 134 and/or other layers thereon (not shown in FIG. 17) that is memorized by the compressed materials after the compression. The notch 149 and projection 150 do not typically represent an actual cross-sectional shape of a folding line. An actual folding line may not show any such a notch or projection. Regardless, the substrate 134 and/or other layers thereon memorizing the lines of compression are easily and readily folded along the line of compression, which facilitate origami folding.

The origami paper 106 may have one or more pressured folding lines. In one embodiment, all of the folding lines are formed as pressured folding lines. In another embodiment, some folding lines are pressured folding lines while others are other forms of folding lines, such as printed or drawn folding lines, perforated folding lines and so forth. To indicate the locations of the pressured folding lines, another form of folding lines is provided simultaneously along the one or more pressured folding lines. Preferably, the other form of folding lines is dotted or non-dotted lines drawn or printed on the substrate 134. The pressured folding line can be combined with any other constructions or embodiments of origami paper described and discussed earlier. For example, one or more of the luminescent layer 136, fragrant layer 139 and blocking layer 141 may be formed on either or both top and bottom sides of the substrate 134.

The functional layers 136, 137, 139, 140 and 141 are formed by any appropriate processes forming such layers including, for example, printing the inks, paints or materials. The pressured folding lines are formed by various processes with use of, for example, knife folders, buckle folders, die-cutters, etc. Those of ordinary skill in the relevant art would appreciate the processes of making these layers and pressured folding lines.

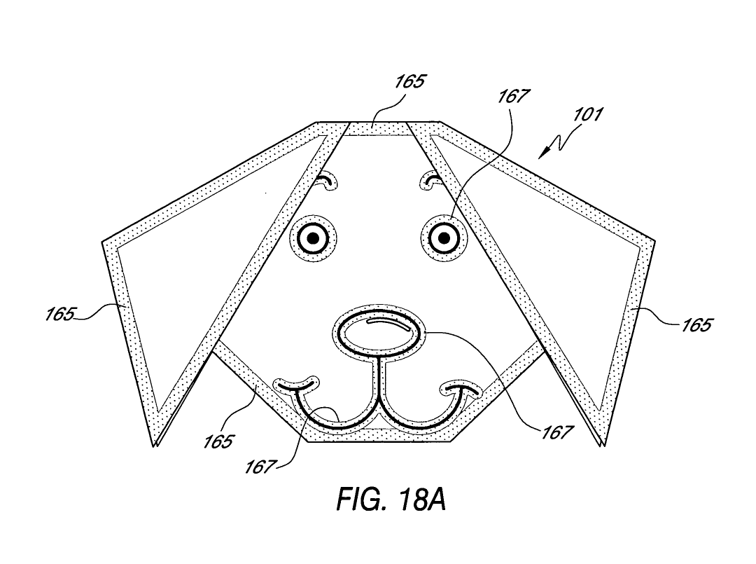

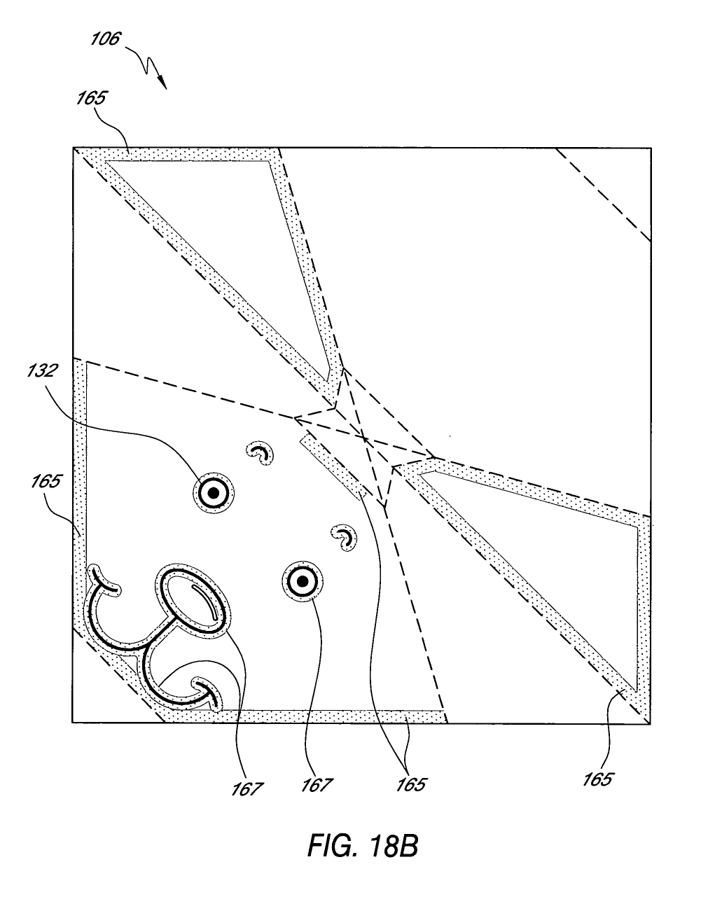

FIGS. 18A and 18B illustrate an exemplary origami and an exemplary origami paper with an outlining feature according to another embodiment of the present invention. The origami 101 of FIG. 18A includes a plurality of colored portions 165 formed along or following folded edges of the origami 101. The origami 101 further includes a plurality of colored portions 167 along or following pre-drawn or attached elements of the origami 101. The colored portions 165 and/or 167 are conspicuously outlining or delineating the shape of the folded origami 101. The colored portions 165 and 167 may be in a single color or in multiple colors. Optionally, the colored portions 165 and 167 are in luminescent colors so that the shape of the origami 101 can be identified in the dark. If the colored portions 165 and 167 are formed with one or more luminescent materials, the portions 165 and 167 may not be conspicuously outlining the origami shape in a bright environment.

The colored portions 165 and 167 may be added after or in the process of the origami folding by coloring with a coloring pen, ink or paint. Alternatively, the colored portions 165 and 167 may be pre-formed on the origami paper 106 as illustrated in FIG. 18B. The pre-formed colored portions 165 and 167 in this origami paper 106 are only those that can be shown from the front view of the completed origami 101 as shown in FIG. 18A. Although not illustrated, other embodiments of the origami paper may include pre-formed colored portions along or following other folding lines. The pre-formed colored portions 165 and 167 are colored in a color different from its neighboring surface of the origami paper 106 so that the outlining effect is more prominent once the origami is folded. For an attachable element 132, the colored portions 167 may be formed around the place where the attachable element 132 is attached. Alternatively or additionally, the attachable element 132 (FIG. 3) may include colorings (not shown) that match with the pre-formed colored portions 165 and 167 of the origami paper 106. Such colored portions on the attachable elements 132 may be formed with a luminescent material.

According to an embodiment of the present invention, one or more origami papers are provided with various stationery articles as an origami kit. The stationery articles are for cutting, pasting, coloring, drawing, creating pressured or perforated folding lines and so forth. Non-exhaustive list of such stationery articles are scissors, a perforator, a line-pressurer, a cutter, an adhesive, an adhesive tape, a crayon, a paint, a paint brush, a pen and a marker. The perforator is a tool to form perforations along a line and can be used to perforate along pre-printed folding lines. The line-pressurer is a tool to form a pressured line and can be used to pressure along pre-printed folding lines. The adhesive includes a liquid glue or glue stick. The paint, crayon, pen and marker are tools for coloring the origami paper or a completed or uncompleted origami. Alternatively or additionally, the paint, crayon, pen and marker may include a luminescent or fragrant material. Additionally, the origami kit may include any attachable elements as described above.

According to an embodiment of the present invention, two or more origami papers are provided with instructions on how to fold the origami paper. The instructions are to fold two or more different origamis, which forms a common theme. For example, the two or more different origamis may form a theme of animals, birds, plants, flowers, automobiles, airplanes, ships and so forth. The two or more origami papers are pre-printed with folding lines to fold different origami shapes, which forms such a theme.

According to another embodiment of the present invention, various shaped origamis are hung through strings to form a mobile. Optionally, the origamis in the mobile have a common theme as described above. In another embodiment, origami papers are provided with various parts for the mobile. Also, the parts for the mobile may be included in the above-described origami kit with stationery.

1. An origami, comprising:
an origami body comprising a plurality of foldings of at least one substantially flexible sheet; and
at least one area on an outer surface of the origami body comprising a luminescent material.

2. The origami of claim 1, wherein the flexible sheet has a thickness selected from about 5 points to about 19 points.

3. The origami of claim 1, wherein the flexible sheet is made of a paper or plastic material.

4. The origami of claim 1, wherein the plurality of foldings comprises at least three foldings of the at least one sheet.

5. The origami of claim 1, wherein the plurality of foldings comprises at least one folding of an overlapped section of the at least one sheet, and wherein the overlapped section is where a part of the sheet is overlapped with another part of the sheet.

6. The origami of claim 1, further comprising at least one fragrant area on an outer surface of the origami body, wherein the at least one area is configured to emit a fragrance upon exposure to air.

7. A method of making the origami of claim 1, comprising:
providing the at least one substantially flexible origami sheet comprising a luminescent material formed on the sheet; and
folding the at least one origami sheet a plurality of times to form the origami body; and
wherein at least part of the luminescent material forms the at least one luminescent area in the outer surface of the origami body.

8. The method of claim 7, wherein the plurality foldings comprises at least five foldings of the at least one sheet.

9. The method of claim 7, wherein the plurality of foldings comprises at least one folding of an overlapped section of the at least one sheet, and wherein the overlapped section comprises a part of the sheet overlapping with another part of the sheet.

10. The method of claim 7, further comprising drawing an element of the origami on the at least one origami sheet or on the outer surface of the origami body, wherein the drawing is performed prior to or during the folding, or after finishing the folding.

11. The method of claim 7, further comprising attaching an element of the origami on the at least one origami sheet or on the outer surface of the origami body, wherein the attachment is performed prior to or during the folding, or after finishing the folding.

12. The method of claim 11, wherein the element for attachment has a luminescent material formed thereon.

13. The method of claim 11, wherein the element for attachment has a fragrant material formed thereon.

14. The method of claim 7, wherein the at least one origami sheet is folded along a plurality of pre-formed folding lines.

15. A method of making the origami of claim 1, comprising:
providing the at least one substantially flexible origami sheet;
folding the at least one origami sheet a plurality of times to form the origami body; and
forming the at least one luminescent area on the outer surface of the origami body.

16. The method of claim 15, wherein the plurality of foldings comprises at least seven foldings of the at least one sheet.

17. The method of claim 15, wherein the forming of the at least one luminescent area is performed prior to, in the process of or after the folding.

18. The method of claim 15, wherein the forming of the at least one luminescent area is one or more selected from the group consisting of:
coloring, with a luminescent material, a surface of the at least one origami sheet or the origami body;
drawing, with a luminescent material, an element on a surface of the at least one origami sheet or the origami body; and
attaching an element comprising a luminescent material to a surface of the at least one origami sheet or the origami body.

19. The method of claim 15, wherein the at least one origami sheet comprises a luminescent material pre-formed thereon.

20. The method of claim 15, further comprising forming a fragrant surface on the origami.

21. An origami, comprising:
an origami body comprising a plurality of foldings of at least one substantially flexible sheet, the origami body further comprising an outer surface; and
means for generating light in the dark that is formed on or attached to the outer surface.

22. An origami, comprising:
an origami body comprising a plurality of foldings of at least one substantially flexible sheet; and
at least one fragrant area on an outer surface of the origami body, wherein the at least one area is configured to emit a fragrance upon exposure to air.

23. The origami of claim 22, wherein the at least one fragrant area is covered with a blocking material, which can be removed to expose the fragrant section to the air, thereby releasing a fragrant scent.

24. The origami of claim 22, wherein the plurality of foldings comprises at least four foldings of the at least one sheet.

25. The origami of claim 22, wherein the flexible sheet has a thickness selected from about 6 points to about 17 points.

26. The origami of claim 22, wherein the outer surface comprises a surface of the at least one sheet constituting a part of the origami body that can be observed from the outside of the origami without unfolding the folded origami body.

27. A method of making the origami of claim 22, comprising:
providing the at least one substantially flexible origami sheet comprising a fragrant material formed on the sheet; and
folding the at least one origami sheet a plurality of times to form the origami body; and
wherein at least part of the fragrant material constitutes the at least one fragrant area on the outer surface of the origami body.

28. The method of claim 27, wherein the plurality of foldings comprises at least six foldings of the at least one sheet.

29. The method of claim 27, wherein the at least one fragrant area is covered with a blocking material, and wherein the method further comprises removing the blocking material to expose the fragrant material to the air, thereby releasing a fragrant scent.

30. The method of claim 27, further comprising drawing on the at least one origami sheet or on the outer surface of the origami body, wherein the drawing is performed prior to or during the folding, or after finishing the folding.

31. The method of claim 27, further comprising attaching attachable elements on the at least one origami sheet or on the outer surface of the origami body, wherein the attachment is performed prior to or during the folding, or after finishing the folding.

32. A method of making the origami of claim 22, comprising:
providing the at least one substantially flexible origami sheet;
folding the at least one origami sheet a plurality of times to form the origami body; and
forming the at least one fragrant area on the outer surface of the origami body.

33. The method of claim 32, wherein the forming of the fragrant area is performed prior to, in the process of or after the folding.

34. The method of claim 32, wherein the forming of the fragrant area is one or more selected from the group consisting of:
forming a fragrant material on a surface of the at least one sheet or the origami body; and
attaching an element comprising a fragrant material on a surface of the at least one sheet or origami body.

35. The method of claim 32, wherein the at least one origami sheet comprises a fragrant material pre-formed thereon.

36. The method of claim 32, further comprising forming at least one luminescent area on the outer surface of the origami body.

37. The method of claim 32, wherein the at least one origami sheet comprises a luminescent material pre-formed thereon.

38. The method of claim 32, wherein the plurality of foldings comprises at least eight foldings of the at least one sheet.

39. An origami, comprising:
an origami body comprising a plurality of foldings of at least one substantially flexible sheet, the origami body further comprising an outer surface; and
means for emitting a scent upon exposure to air, the means being formed or attached to the outer surface of the origami body.

40. An origami, comprising:
an origami body forming a shape, the shaped origami body comprising a plurality of foldings of at least one substantially flexible sheet;
a plurality of colored portions formed on the origami body; and
wherein the plurality of colored portions substantially outlines the shape of the origami body.

41. The origami of claim 40, wherein each colored portion is a luminescent color.

42. The origami of claim 40, wherein the plurality of colored portions is a single color.

43. The origami of claim 40, wherein the plurality of colored portions is two or more colors.

44. The origami of claim 40, wherein each colored portion comprises a substantially straight line.

45. The origami of claim 40, wherein the plurality of colored portions is formed along all or part of the foldings.

46. The origami of claim 40, wherein the plurality of colored portions conspicuously outlines the shape of the origami body.

47. A method of making the origami of claim 40, the method comprising:
providing the at least one substantially flexible origami sheet;
folding the at least one origami sheet a plurality of times to form the shaped origami body; and
forming the plurality of colored portions on the at least one flexible origami sheet or the shaped origami body so as to substantially outline the shape of the origami body.

48. The method of claim 47, wherein the plurality of colored portions is added in the process of or after finishing the folding.

49. A method of making the origami of claim 40, the method comprising:
providing the at least one substantially flexible origami sheet; and
folding the at least one origami sheet a plurality of times to form the shaped origami body;
wherein the plurality of colored portions is pre-formed on the at least one origami sheet.
